(19) United States
(12) Patent Application Publication
(10) Pub. No.: US 2002/0149195 A1
(43) Pub. Date: Oct. 17, 2002

(54) PERSONALIZED POSTAGE STAMPS

(76) Inventor: JOE PAT BEASLEY, SAN ANTONIO, TX (US)

Correspondence Address: RENNER OTTO BOISSELLE & SKLAR, 1621 EUCLID AVENUE, 19TH FLOOR, CLEVELAND, OH, 44115, US

(21) Appl. No.: 09/326,712

(22) Filed: Jun. 7, 1999

(51) Int. Cl. G09F 3/00

(52) U.S. Cl. 283/71

(57) ABSTRACT

A sheet of (preferably twenty) personalized postage stamps may, be applied to pieces of mail or given as a gift to loved ones. Each individual stamp will include the country of issue (e.g. U.S.A.) and a monetary value (e.g. 33¢ or 55¢). The sheet of personalized stamps may contain a seal showing collectability value or proof of authentication. There is a method of retrieving an the personalized image and sizing the image before it is copied or printed onto the appropriate areas of the stamp sheet. The consumer may request the operator of the computer system to apply a protective coating to protective the life of the stamp. In addition, the consumer may request that the finished product be framed as a picture.

### BACKGROUND OF THE INVENTION

1. Field of the Invention

The present invention relates to a personalized postal stamps system and methods of making the same. The postal stamp is particularly intended for use by the typical governmental postal service, and authorized private and public organizations that handle parcel, package and mail delivery.

2. Description of the Related Art

In the past, the postal services of many countries have offered a variety of modifications to traditionally designed postage stamps. Customarily, the post offices have been providing stamps in the form of perforated sheets with multiple rows of postage stamps. Each sheet is rectangular in shape and the back surface of the sheet is coated with a water-activated adhesive. The adhesive or gum is generally provided in the production of stamps in the form of a solution following the printing process and then dried. The printed paper sheet is then perforated and cut into sheets suitable for sale. Adhesives used on stamps in the past have been gum arabic, animal or fish glue, and dextrin.

Stamps haves had many face lifts and minor improvements over the years. U.S. Pat. No. 3,565,463, issued to D. A. Taylor on Feb. 23, 1971, U.S. Pat. No. 5,267,754, issued to Wittich Kaule on Dec. 7, 1993, and U.S. Pat. No. 5,685,570, issued to Gray, et al. on Nov. 11, 1997, all describe different ways a stamp may incorporate a security feature which allows the postal authorities to verify the validity of a stamp. U.S. Pat. No. 3,995,741, issued to Joseph Henderson on Dec. 7, 1976, and U.S. Pat. No. 4,715,622, issued to Ameer Mikhail on Dec. 29, 1987, describes different ways in altering stamps to incorporate a method of providing a destination code to aid the post office in sorting and delivering the mail more quickly.

Many philatelists have stressed the need for improving the aesthetic value of postage stamps. Other countries besides the United States of America produce equally outstanding stamps. However, some novel ideas have not been appealing to many postal service authorities. U.S. Pat. No. 5,423,573, issued to Georges de Passille on Jun. 13, 1995, describes a composite postage stamp that comprises a larger definitive part and a separate complementary smaller pre-made part. Each part has a printed front surface and an adhesive rear surface coating. Both parts have adhesive backs so that the decorated complementary design may be adhered to the front face of the stamp and the stamp adhered to the postal article. Both the definitive and complementary parts may be prefabricated by the post office and offered together as a collection. The difficulty with this patent is that only a few pre-made complementary parts are offered which limits the consumer's choices.

In many cases the postal service will not endorse novel ideas in stamp alterations. One reason would be the lack of governmental control over how the stamps themselves are altered. If any personalized image can be placed on a stamp without some form of regulation, there could possibly be a problem with obscenity, copyright, and trademark issues. U.S. Pat. No. 5,873,605, issued to Kenneth Kaplan on February 23, describes a method for making, personalized postage stamps. A consumer must first pose in front of a vending machine, similar to a passport photo machine in the shopping malls. The first region is the lawful stamp and may be printed by the vending machine. The first region occupies an outer margin of the stamp and surrounds a second region. The second region presents the image in the form of a person when the stamp is purchase from the vending machine. The vending machine then forms the first and second region images in a single operation at different times by different operations. The problem with this patent is that the invention limits the image to a person or photographable object, due to the fact that the subject being photographed must pose or be positioned in front of the vending machine.

An ideal personalized postage stamp would permit the consumer to bring in any image or photo of their choice to be placed within the border of each postage stamp. Thus the size of the image will not be strictly limited to a person's face. In addition, there would be a regulating process which would prevent obscene photos, and copyright and trademark infringement problems, before the image is placed on the personalized postage stamps.

None of the above inventions and patents, taken either singularly or in combination, is seen to describe the instant invention as claimed. Thus a personalized postage stamps solving the aforementioned problems is desired.

### SUMMARY OF THE INVENTION

The present invention provides a means to combine a personalized image with postage stamps to be applied to pieces of mail or given as a gift to loved ones. In particular, sheets of prefabricated postage stamps are provided by the post office to authorized dealers that includes spaces for a personalized image to be printed or copied thereon. A sheet of twenty personalized postage stamps has a back and front layer. The back layer comprises an inner surface which has a coating or laminate that permits another layer to be easily peeled away, generally known by the term “crack and peel.” The front layer has a print side and an adhesive side. The adhesive side contains a pressure-sensitive or acrylic adhesive or cohesive which requires no moistening for activation for attaching the stamp to a carrier. Each individual stamp will include the country of issue (e.g. U.S.A.) and a monetary value (e.g. 33¢ or 55¢).

The print side may include a personalized image, monetary value, and country or organization name, which may be in the form of letters, numbers, words, designs, bar codes or other forms of human or machine readable information. The shape of each stamp border is typically, but not limited too, a portrait or landscape design. The print side may contain a seal which can be adhered to the finished product. The seal may have indicia referring to a collectability value or proof of authentication.

The present invention also provides a method of retrieving an image and sizing the image before it is copied or printed onto the appropriate areas of the stamp sheet. The method of making a personalized postage stamp includes the following steps: scanning, and/or retrieving an image into storage from either a remote or local storage medium; storing the image in a data base; selecting a substrate for which the image is to be added; sizing the retrieved image to fit the selected substrate; applying the image(s) to the selected substrate; evaluating the combined substrate and image product; and optionally applying a protective coating onto the printed side of the final product and/or framing the finished product.

In making a personalized postage stamp the consumer must provide a personalized image to an authorized dealer who operates a computer system designed to retrieve images. The consumer may supply the authorized dealer with an image sent via the email as an attachment file or the dealer may use an image off of a web site from the Internet. The consumer may bring in an image stored on a diskette or CD which can be retrieved as an image file and stored in the image data base. The final steps are optional to the consumer. The consumer may request the operator of the computer system to apply a protective coating to prolong the life of the stamp. In addition, the consumer may request that the finished product be framed as a picture.

Personalized stamp sheets may only be obtained at the post offices by authorized organizations, unless technology permits governmental control of affixing images. A postal article with a personalized stamp would be retrieved by the post office and delivered to a known device for detecting the presence of a genuine stamp and for canceling the stamp.

Accordingly, it is a principal object of the invention to provides a means to combine a personalized image with postage stamps to be applied to pieces of mail or given as a gift to loved ones.

It is another object of the invention to provide a type of personalized postage stamps that attracts the philatelists and non-philatelists.

It is a further object of the invention to provide a regulating process which prevents obscene photos, copyright and trademark infringement problems before the image is placed on the personalized postage stamps.

Still another object of the invention allows the consumer to, supply an authorized dealer with any form of personalized image.

It is an object of the invention to provide improved elements and arrangements thereof for the purposes described which is inexpensive, dependable and fully effective in accomplishing its intended purposes.

These and other objects of the present invention will become readily apparent upon further review of the following specifications and drawings.

### BRIEF DESCRIPTION OF THE DRAWINGS

FIG. 1 is an environmental, perspective view of a sheet of personalized postage stamps according to the present invention.

FIG. 2 is a partially exploded, perspective view of a sheet of personalized postage stamps according to the present invention.

FIG. 3 is a block diagram of the method of making a personalized postage stamp according to the present invention.

Similar reference characters denote corresponding features consistently throughout the attached drawings.

### DETAILED DESCRIPTION OF THE PREFERRED EMBODIMENTS

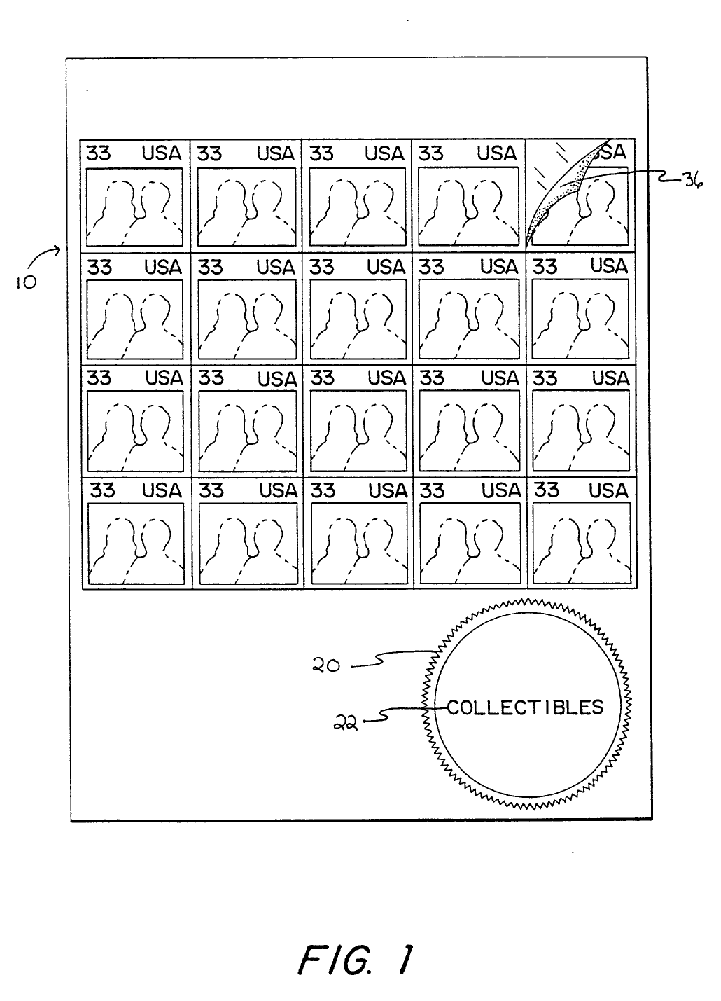

The present invention provides a means to combine a personalized image with postage stamps. A sheet of such stamps is designated as 10 in the drawings. FIG. 1 shows a sheet of personalized postage stamps 10 with a seal 20 containing indicia 22. In addition, the present invention includes a method of retrieving an image and sizing the image before it is copied or printed onto the appropriate areas of the stamp sheet.

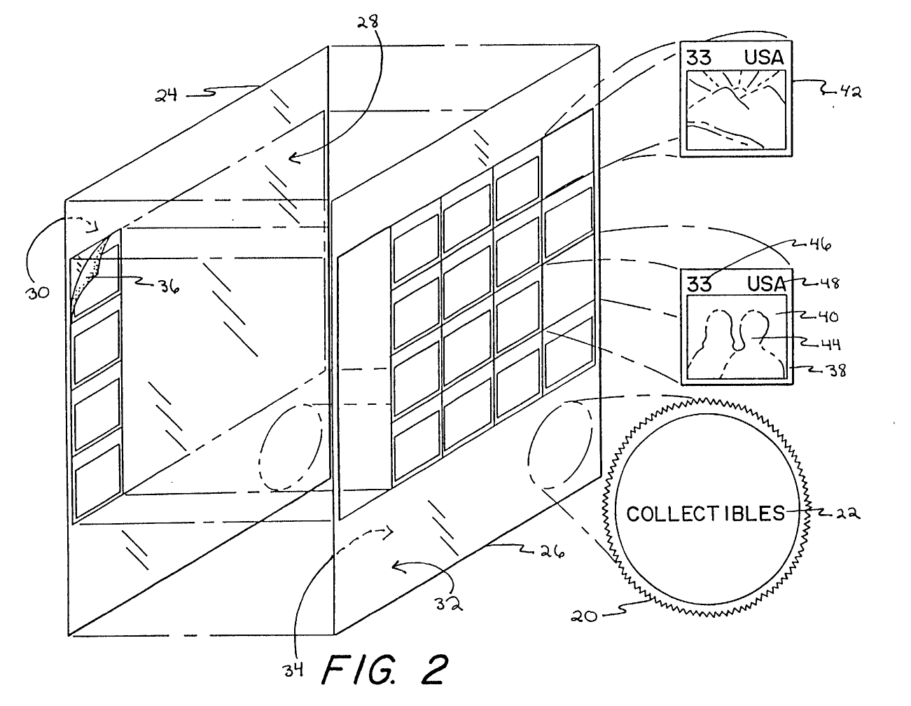

FIG. 2 shows a sheet of personalized stamps 10 comprising a back 24 and front 26 layer. The sheet of personalized postage stamps 10 is made from paper or synthetic material. The back layer 24 comprises an inner 28 and outer 30 surface. The inner surface 28 of the back layer 24 preferably has a coating or laminate that permits another layer to be easily peeled away. The front layer 26 comprises a print side 32 thereon characterizing the stamp(s) and an adhesive side 34 which adheres to a substrate. The adhesive side 34 of the front layer 26 contains a pressure-sensitive or acrylic adhesive or cohesive which requires no moistening for activation for attaching the stamp to a carrier substrate.

In the stamp sheet, various materials are selected such that they possess the following relative affinities such as adhesion and/or cohesion. Lately, the United States Postal Service has been utilizing this certain type of postage stamps generally known by the term “crack and peel.” These types of stamps are carried on a back sheet layer 24 and can be peeled 36 and applied to a postal article. The “crack and peel” sheets are typically made by Avery Dennison. Although the “crack and peel” postage stamp sheet is the preferred composition, the present invention is not limited to this form.

The print side 32 of the front layer 26 has a major definitive portion 38 and a minor image-bearing portion 40. The major definitive portion 38 comprises the border of each personalized stamp 42. The minor image-bearing portion 40 comprises the personalized image 44 supplied by the consumer. The print side 32 of the front sheet layer 26 may contain a transparent or translucent outer laminate having an information containing pattern printed on its inner surface. The laminate would have sufficient transparency or translucency so that a pattern printed on one side is visible through the laminate layer. The chemical nature of the laminate is not critical so long as it has sufficient film integrity for its intended use and provides a surface with appropriate ink affinity characteristics. In addition, the outer laminate must permit the approved post office security canceling inks to penetrate and dry. The laminates may include polyester films or polymer film which are known in the film art.

The print side 32 may contain a seal 20 which can be adhered to the finished product. The seal 20 may have indicia 22 referring to a collectability value or proof of authentication. The personalized stamp 10 may include a personalized image 44, monetary value 46, and country or organization name 48, which may be designated by letters, numbers, words, designs, bar codes or other forms of human or machine readable information. The shape of each stamp border 38 is typically, but not limited too, a portrait or landscape design. The preferred embodiment of the present invention will include a sheet 10 with twenty stamps 42. As illustrated in FIG. 2, each individual stamp 42 will include the country of issue 48 (e.g. U.S.A.) and a monetary value 46 (e.g. 33¢ or 55¢). The preferred stamp 42 is shown in FIG. 2 where the country of issue 48 and the monetary value 46 is pre-printed within the border 38 of the stamps 42 provided by the postal service. However, if technology permits, the country of issue 48 and monetary value 46 may overlap the image 44 as its printed or copied from the computer system. The country of issue 48 and/or monetary value 46 will preferably, but not limited too, occupy the region within the stamp border 38.

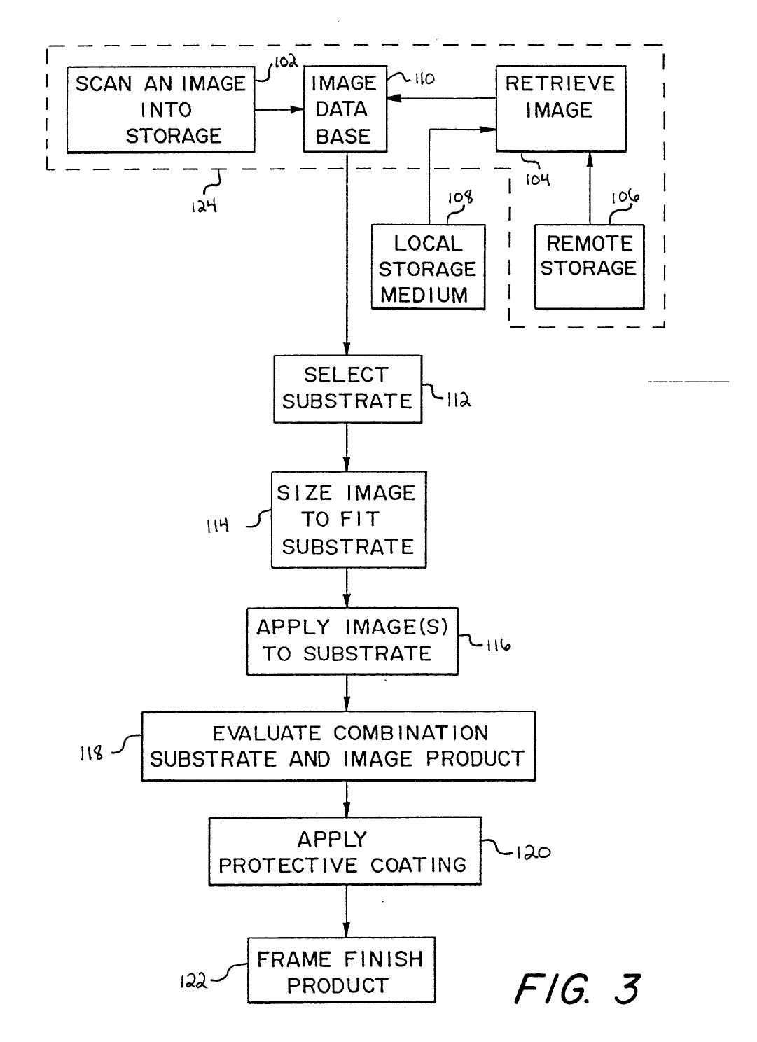

FIG. 3 is a block diagram of a method of making a personalized postage stamp which comprises the following steps: scanning 102 and/or retrieving an image 104 into storage from either a remote 106 or local storage medium 108; storing the image in a data base 110; selecting a substrate 112 for which the image is to be added; sizing the retrieved image to fit the selected substrate 114; applying the image(s) to the selected substrate 116; evaluating the combined substrate and image product 118; and optionally applying a protective coating 120 onto the printed side of the final product and/or framing the finished product 122. Steps 102, 104, 106, and 110 would all be processed by a conventional computer system 124 including a scanning device, a port that accepts diskettes and compact disks (CD's), and Internet access with email.

The first step in making a personalized postage stamp 10 requires the consumer to provide a personalized image 44 to an authorized dealer who operates the computer system 124 designed to retrieve images 104. The retrieved images 104 can be done several ways. One way is for the consumer to personally present a photograph or image that can be scanned 102 and stored by the operator into the image data base 110 of the computer system 124.

Another way to retrieve an image 104 can be from a local 108 or remote storage medium 106. An example of a remote storage medium 106 would be for the consumer to supply the authorized dealer with an image sent via the email as an attachment file or to use an image off of a web site from the Internet. An example of a local storage medium 108 would involve the consumer bringing in an image stored on a diskette or CD which can be retrieved 104 as an image file and stored in the image data base 110. The present invention would not be limited to the above described storage mediums 106 and 108. Present and future technology may incorporate different forms of local 108 and remote storage mediums 106 such a digital cameras and visual telecommunications.

After an image has been stored in the image data base 110 the consumer would chose a substrate 112 to be added to the image-bearing portion 40 on the stamp sheet 10. There are many software programs on the market that can retrieve and size any image 114 and communicate the adjusted image to be printed or copied 116 onto a specific sized area of a substrate 112. The software such as PHOTOSHOP can retrieve 104, store 110, and size the image 114 to fit the appropriate image-bearing portion 40. Such software may also reproduce and size 114 several different images to be printed or copied 116 onto the many pre-dimensioned image-bearing portions 40 on the substrate 112.

Once the image has be properly sized 114 to fit the image bearing portion 40 on the substrate 112, the next step would be to apply the image(s) 116 to the selected substrate 112. A printer or copier would be the chosen mode to apply image(s) 116 to the substrate 112. The preferred printer or copier would be the Cannon or Xerox color high speed raster imaging processor. The raster image processor is a computer device that converts PostScript print data created in a desktop publishing program, such as PRINTSHOP, and renders the lines and curves that make up graphics into a series of pixels that match the resolution of the specific output, device such as color laser copier or printer. The raster image processor begins by breaking the PostScript file into individual objects, which it processes, one by one until it has built a complete high-resolution bitmap. The raster image processor then passes the bitmap or pixel grids to the output device's marking engine, which generates the actual spots of ink or toner that are put on the sheet of stamp paper to reproduce the image.

The next step would evaluate 118 the combination of the selected substrate and the final image product. The authorized dealer would apply an ink cancellation stamp over the finished product if the consumer is not satisfied and the authorized dealer would send the unwanted canceled product back to the postal service for a credit or refund. The final steps are optional to the consumer. The consumer may request the operator of the computer system 124 to apply a protective coating 120 to protective the life of the stamp 42. In addition, the consumer may request that the finished product be framed 122 as a picture.

Personalized stamp sheets 10 may only be obtained at the post offices by authorized organizations, unless technology permits governmental control of affixing images. Processing and management of the various kinds of paper in accordance with the stamp sheets 10, and the great organizational efforts this involves, are avoided, by only allowing governmental control. Cancellation of stamps 42 by applying a postmark does not provide sufficient protection against illegal reuse of stamps 42. Better techniques of cancellation and authentification may be incorporated in the sheets of stamps 10 provided from the post offices to the authorized dealers.

One technique of authentication or cancellation used in the past are suitable fluorescent substances such as luminophores (chlorophyll) which can be excited in the visible or infrared (IR) spectral ranges. Another technique used are magnetic markings of magnetizable iron oxide for magnet detection device. In addition an electrically conductive marking technique can be used by mixing a metal powder or pieces of metallic thread in stamp 42. A postal article with a personalized stamp 42 would be retrieved by the post office and delivered to a known device for detecting the presence of a genuine stamp and for canceling the stamp 42.

Another concern would be to incorporate a label and/or a machine-readable marking material suitable for automatic processing. This would enable faster machine sorting and routing of mail to the proper containers for delivery.

The present invention provides a means to combine a personalized image 44 with postage stamps 42 to be applied to pieces of mail. This type of personalized postage stamps 10 not only attracts the philatelists, but non-philatelists too.

It is to be understood that the present invention is not limited to the embodiments described above, but encompasses any and all embodiments within the scope of the following claims.

I claim:

1. A personalized postage stamp system comprising:
a plurality of sheets, said sheets having an inner and outer surface, at least one said sheet having a print side and an adhesive side, said print side having a plurality of major definitive portions, said adhesive side being suited to adhere to a carrier substrate; and
at least one personalized postage stamp on said print side having a border and a minor image-bearing portion, said minor image bearing portion being dimensioned and configured to enclose a said major definitive portion.

2. A personalized postage stamp system according to claim 1, wherein said major definitive portion is said border of each stamp on said print side of said layer.

3. A personalized postage stamp system according to claim 2, wherein said major definitive portion has a shape selected from the group consisting of portrait and landscape.

4. A personalized postage stamp system according to claim 2, wherein said major definitive portion contains printed indicia designating a monetary value and a country of origin.

5. A personalized postage stamp system according to claim 1, wherein said minor image-bearing portion on said print side is dimensioned and configured to receive a personalized image supplied by a consumer.

6. A personalized postage stamp system according to claim 1, wherein said personalized postage stamp further comprises a security and cancellation feature.

7. A personalized postage stamp system according to claim 1, wherein said personalized postage stamp further comprises a destination code.

8. A personalized postage stamp system according to claim 1, wherein said print side of said layer further comprises a seal having printed indicia.

9. A personalized postage stamp system according to claim 1, further comprising a back sheet, said back sheet having an inner and outer surface, said inner surface is lined with a material permitting another said layer having a said adhesive side to be easily peeled away.

10. A personalized postage stamp system according to claim 9, wherein said adhesive side further comprises a pressure-sensitive adhesive.

11. A method of making personalized postage stamps comprising the steps of:
(a) scanning an image into storage;
(b) retrieving an image from storage, said storage being selected from the group consisting of a local storage medium and a remote storage medium:
(c) storing the image in a data base;
(d) selecting a substrate to which the retrieved image will be added;
(e) sizing the retrieved image to fit the selected substrate;
(f) applying the image to the selected substrate; and
(g) evaluating the combined substrate and final image, product.

12. A method as claimed in claim 11, wherein steps (a), (b) (i), and (c) are processed by a conventional computer system, the computer system including a scanning device, a port that accepts portable storage mediums such as diskettes and compact disks, and Internet with email access.

13. A method as claimed in claim 11, wherein the remote storage medium comprises an image sent via the Internet and email.

14. A method as claimed in claim 11, wherein the local storage medium comprises an image in the form of a file loaded onto a diskette and compact disk.

15. A method as claimed in claim 11, wherein said sizing the retrieved image to fit the selected substrate is performed by a conventional sizing image software.

16. A method as claimed in claim 11, wherein said applying the image to fit the selected substrate is performed by a high speed color printer.

17. A method as claimed in claim 11, wherein said applying the image to fit the selected substrate is performed by a high speed color copier.

18. A method as claimed in claim 11, further comprising the step of (h) adding a protective coating onto the said print side after step (g).

19. A method as claimed in claim 11, further comprising the step of (i) framing the final product after step (g).
